(19) United States
(12) Patent Application Publication
(10) Pub. No.: US 2021/0075281 A1
(43) Pub. Date: Mar. 11, 2021

(54) ROTOR AND MOTOR

(71) Applicant: NIDEC SANKYO CORPORATION, NAGANO (JP)

(72) Inventor: Kazumi FURUBAYASHI, NAGANO (JP)

(73) Assignee: NIDEC SANKYO CORPORATION, Nagano (JP)

(21) Appl. No.: 16/977,809

(22) PCT Filed: Mar. 1, 2019
(86) PCT No.: PCT/JP2019/007975

§ 371 Date: Sep. 2, 2020

(30) Foreign Application Priority Data
Mar. 12, 2018 (JP) 2018-043705

(51) Int. Cl. H02K 1/30

(52) U.S. Cl. CPC H02K 1/30

(57) ABSTRACT

A rotor and a motor are provided. In the motor, the rotor has a rotor magnet in a cylindrical rube shape disposed coaxially around a rotation shaft, and a first bushing provided with a center hole into which the rotation shaft has been pressed. A first end face of the first bushing has formed thereon an outflow prevention wall for preventing the outflow of an adhesive, the outflow prevention wall being formed by a radially outward-facing circumferential face of a wall forming part, which includes a rib-shaped protruded part and which is formed at a position set apart radially inward from an outer circumferential edge of the first end face. The first bushing is a metal plate, and the wall forming part is formed by press working. A second bushing is substantially the same as the first bushing.

### TECHNICAL FIELD

The present invention relates to a rotor in which a rotor magnet is fixed to a rotation shaft through a bushing, and to a motor including the rotor.

### BACKGROUND ART

A rotor which is used in a motor includes a rotor magnet around a rotation shaft. When such a rotor is to be structured, in a case of a structure that a rotation shaft is inserted into a center hole of a cylindrical-shaped rotor magnet, a volume of the rotor magnet is large and thus, a cost of the rotor magnet is increased and the rotor becomes heavy. In order to prevent the problems, a structure has been proposed in which an outer circumferential edge of a bushing whose center hole is press-fitted with a rotation shaft is fixed to an inner peripheral face of a rotor magnet in a cylindrical tube shape by an adhesive (see Patent Literature 1). According to this structure, a portion between the rotation shaft and the rotor magnet can be made hollow and thus, a weight of the rotor can be reduced and, in addition, a volume of the rotor magnet can be reduced. Further, Patent Literature 1 has proposed that a step part is formed at an outer circumferential edge of the bushing and a reservoir part of an adhesive is formed by using the step part and thereby, the bushing and the rotor magnet are surely fixed to each other.

### CITATION LIST

### Patent Literature

[Patent Literature 1] Japanese Patent Laid-Open No. 2000-78824

### SUMMARY OF THE INVENTION

### Problems to be Solved by the Invention

In the motor described in Patent Literature 1, in order to apply a sufficient amount of adhesive, a reservoir part for an adhesive is required to make a sufficient size. In a structure that a reservoir part for an adhesive is formed by using a step part formed at an outer circumferential edge of a bushing like the motor described in Patent Literature 1, in order to make the reservoir part for an adhesive set in a sufficient size, a structure is required that a width of the step part is increased or that the step part is formed to be deep. However, it may be difficult that an appropriate step part is provided at an outer circumferential edge of the bushing depending on thickness or the like of the bushing.

In view of the problem described above, an objective of the present invention is to provide a rotor and a motor in which an appropriate amount of adhesive is capable of being provided between a bushing for fixing a rotor magnet to a rotation shaft and an inner peripheral face of the rotor magnet.

### Means to Solve the Problems

To solve the above-mentioned problem, the present invention provides a rotor including a rotation shaft, a rotor magnet in a cylindrical tube shape which is coaxially disposed with the rotation shaft around the rotation shaft, and a bushing in a plate shape which is provided with a center hole to which the rotation shaft is fixed and a first end face which faces an outer side in an axial line direction of the rotation shaft, an outer circumferential edge of the first end face being fixed to an inner peripheral face of the rotor magnet with an adhesive. The first end face is formed with a wall forming part structured of one of a recessed part in a groove shape and a protruded part in a rib shape so as to be extended in a circumferential direction at a position separated from the outer circumferential edge to an inner side in a radial direction, and the adhesive is provided between an outflow prevention wall which is structured of a circumferential face which faces an outer side in the radial direction of the wall forming part and the inner peripheral face of the rotor magnet and thereby the bushing and the rotor magnet are adhesively fixed to each other.

According to the present invention, a portion between the rotation shaft and the rotor magnet can be made hollow and thus, a weight of the rotor can be reduced and, in addition, a volume of the rotor magnet can be reduced. Further, the first end face of the bushing is formed with the outflow prevention wall by using the circumferential face of the wall forming part which is formed so as to face an outer side in the radial direction at a position separated from the outer circumferential edge to an inner side in the radial direction. Therefore, when an adhesive is applied between the outflow prevention wall and the inner peripheral face of the rotor magnet, even in a case that the adhesive is going to flow to an inner side in the radial direction, the adhesive is blocked by the outflow prevention wall and thus, the adhesive is difficult to flow to the inner side in the radial direction. Accordingly, a sufficient amount of adhesive can be provided between the outflow prevention wall and the inner peripheral face of the rotor magnet and thus, the bushing and the rotor magnet can be adhesively bonded to each other firmly.

In the present invention, it may be structured that the bushing is a metal plate, and a second end face of the bushing which faces an inner side in the axial line direction of the rotation shaft is formed with the other of the recessed part and the protruded part at a position overlapped with the wall forming part. In other words, it may be structured that the wall forming part can be formed by press working to the bushing (metal plate). Therefore, the bushing can be manufactured efficiently. Also in this case, press working to the bushing (metal plate) is performed at a position separated from the outer circumferential edge to an inner side in the radial direction and thus, in comparison with a case that press working to the bushing (metal plate) is performed on the outer circumferential edge, the wall forming part and the outer circumferential edge of the bushing are easily finished in appropriate shapes.

In the present invention, it may be structured that each of the protruded part and the recessed part is formed so that each of a circumferential face on an inner side in the radial direction and a circumferential face on an outer side in the radial direction is formed in an inclined face. According to this structure, the wall forming part is easily formed by press working to the bushing (metal plate).

In the present invention, it may be structured that the bushing is formed with a through hole which penetrates through in the axial line direction. According to this structure, in a state that the rotor magnet is fixed to the rotation shaft by the bushing, a space surrounded by the rotor magnet and the bushing is communicated with an outer side through the through hole of the bushing. Therefore, even when air in the space surrounded by the rotor magnet and the bushing expands or contracts with change of environment temperature or the like, detachment of the adhesive due to moving of the bushing in the axial line direction can be restrained. In this case, it may be structured that the through hole is connected with the wall forming part. According to this structure, the adhesive can be restrained from flowing to an inner side in the radial direction by the through hole.

In the present invention, it may be structured that the outflow prevention wall is provided with water repellency. According to this structure, the adhesive can be effectively restrained from flowing to an inner side in the radial direction by the outflow prevention wall having water repellency.

In the present invention, it may be structured that the bushing is provided at two positions separated in the axial line direction.

A motor using the rotor in accordance with the present invention includes a stator which faces the rotor magnet on an outer side in the radial direction. In this motor, it may be structured that a washer is provided so as to overlap with the first end face on an inner side in the radial direction with respect to the wall forming part.

### Effects of the Invention

According to the present invention, a portion between the rotation shaft and the rotor magnet can be made hollow and thus, a weight of the rotor can be reduced and, in addition, a volume of the rotor magnet can be reduced. Further, the first end face of the bushing is formed with the outflow prevention wall by using the circumferential face of the wall forming part which is formed so as to face an outer side in the radial direction at a position separated from the outer circumferential edge to an inner side in the radial direction. Therefore, when an adhesive is disposed between the outflow prevention wall and the inner peripheral face of the rotor magnet, even in a case that the adhesive is going to flow to an inner side in the radial direction, the adhesive is blocked by the outflow prevention wall and thus, the adhesive is difficult to flow to the inner side in the radial direction. Accordingly, a sufficient amount of adhesive can be provided between the outflow prevention wall and the inner peripheral face of the rotor magnet and thus, the bushing and the rotor magnet can be adhesively bonded to each other firmly.

### BRIEF DESCRIPTION OF THE DRAWINGS

FIG. 1 is a cross-sectional view showing a motor to which the present invention is applied.

FIG. 2 is a cross-sectional view showing a rotor which is used in the motor shown in FIG. 1.

FIG. 3 are explanatory views showing the rotor in FIG. 2 which are viewed in an axial line direction.

FIG. 4 are perspective views showing a state in which a rotor magnet is not shown in the rotor in FIG. 2.

FIG. 5 are exploded perspective views showing the rotor which is disassembled into respective members from the state shown in FIG. 4.

### DESCRIPTION OF EMBODIMENTS

A rotor and a motor to which the present invention is applied will be described with reference to the accompanying drawings. In a motor 1 described below, a rotation center axial line of a rotation shaft 12 is defined as an axial line “L”, and a direction where the rotation center axial line of the rotation shaft 12 is extended is defined as an axial line “L” direction. Further, in the following descriptions, one side to which the rotation shaft 12 is protruded is referred to as an output side “L1”, and an opposite side (the other side) to the side where the rotation shaft 12 is protruded is referred to as an opposite-to-output side “L2”.

(Entire Structure)

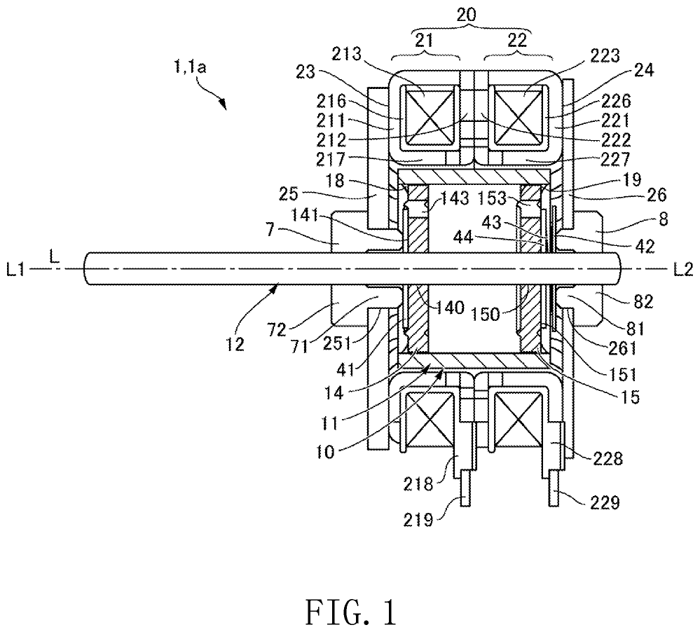

FIG. 1 is a cross-sectional view showing a motor to which the present invention is applied. A motor 1 shown in FIG. 1 is a stepping motor 1a, which includes a rotor 10 having a rotor magnet 11 on an outer side in a radial direction with respect to a rotation shaft 12 and a tube-shaped stator 20 which faces an outer peripheral face of the rotor magnet 11. An “N”-pole and an “S”-pole are alternately disposed in a circumferential direction on the outer peripheral face of the rotor magnet 11.

The stator 20 includes a pair of stator assemblies 21 and 22 which are disposed so as to be overlapped with each other in the axial line “L” direction. The stator assemblies 21 and 22 respectively include insulators 216 and 226, coils 213 and 223 which are wound around the insulators 216 and 226, and stator cores 211 and 212 and stator cores 221 and 222 which are disposed on both sides of the insulators 216 and 226 in the axial line “L” direction. The stator core 211 is an outer stator core which covers a face on the output side “L1” of the insulator 216, and the stator core 212 is an inner stator core which covers a face on the opposite-to-output side “L2” of the insulator 216. The stator core 221 is an outer stator core which covers a face on the opposite-to-output side “L2” of the insulator 226, and the stator core 222 is an inner stator core which covers a face on the output side “L1” of the insulator 226. Each of the stator cores 211 and 221 is formed in a “U”-shape in cross section and tube-shaped parts on an outer peripheral side of the stator cores 211 and 221 structure a motor case.

The stator cores 211, 212, 221 and 222 are respectively provided with a plurality of pole teeth 217 and 227 which are stood up along inner peripheral faces of the insulators 216 and 226. In a state that the stator assembly 21 has been structured, the pole teeth 217 formed in the stator core 211 are interposed between the pole teeth 217 formed in the stator core 212, and the pole teeth 217 formed in the stator core 211 and the pole teeth 217 formed in the stator core 212 are set in a state that they are alternately disposed in the circumferential direction. Further, in a state that the stator assembly 22 has been structured, the pole teeth 227 formed in the stator core 221 are interposed between the pole teeth 227 formed in the stator core 222, and the pole teeth 227 formed in the stator core 221 and the pole teeth 227 formed in the stator core 222 are set in a state that they are alternately disposed in the circumferential direction.

The insulators 216 and 226 are integrally formed with terminal blocks 218 and 228, and terminals 219 and 229 are fixed to the terminal blocks 218 and 228. On both end faces of the stator 20, an output side end plate 25 is fixed to an end part 23 on the output side “L1”, and an opposite-to-output side end plate 26 is fixed to an end part 24 on the opposite-to-output side “L2”.

In this embodiment, an output side radial bearing 7 which rotatably supports the rotation shaft 12 on the output side “L1” is held by utilizing the output side end plate 25. More specifically, the output side end plate 25 is formed with a hole 251, and the output side radial bearing 7 is held by the output side end plate 25 in a state that the output side radial bearing 7 is fitted into the hole 251. The output side radial bearing 7 is provided with a tube part 71 fitted to the hole 251 and a flange part 72 which is enlarged in diameter on the output side “L1” of the tube part 71 and has a diameter larger than the tube part 71. The output side radial bearing 7 is made of an oil-impregnated sintered bearing or the like. Further, an opposite-to-output side radial bearing 8 which rotatably supports the rotation shaft 12 on the opposite-to-output side “L2” is held by utilizing the opposite-to-output side end plate 26. More specifically, a hole 261 is formed in the opposite-to-output side end plate 26, and the opposite-to-output side radial bearing 8 is held by the opposite-to-output side end plate 26 in a state that the opposite-to-output side radial bearing 8 is fitted to the hole 261. The opposite-to-output side radial bearing 8 is provided with a tube part 81 which is fitted to the hole 261, and a flange part 82 which is enlarged in diameter on the output side “L1” of the tube part 81 and has a diameter larger than the tube part 81. The opposite-to-output side radial bearing 8 is made of an oil-impregnated sintered bearing.

In the motor 1, a ring-shaped washer 41 through which the rotation shaft 12 is penetrated is disposed between the output side radial bearing 7 and the rotor 10. Further, a ring-shaped washer 42, an urging member 43 structured of a ring-shaped disk spring, a coiled spring or the like, and a ring-shaped washer 44 are disposed from the opposite-to-output side “L2” toward the output side “L1” between the opposite-to-output side radial bearing 8 and the rotor 10. The rotor 10 is urged toward the output side “L1” by the urging member 43.

(Structure of Rotor 10)

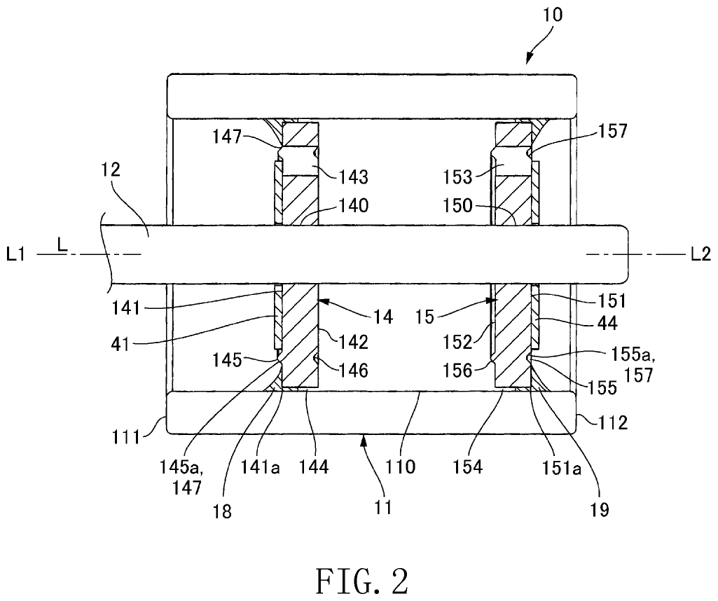

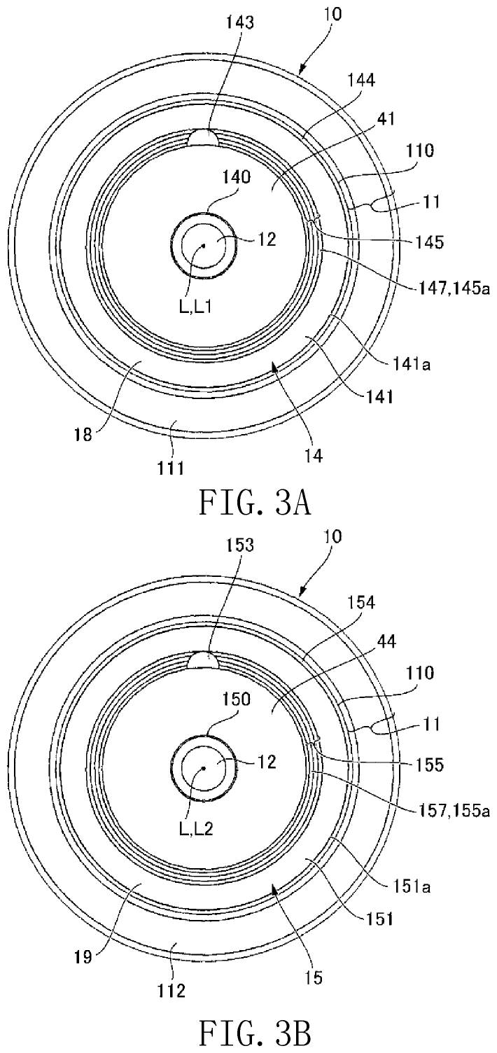

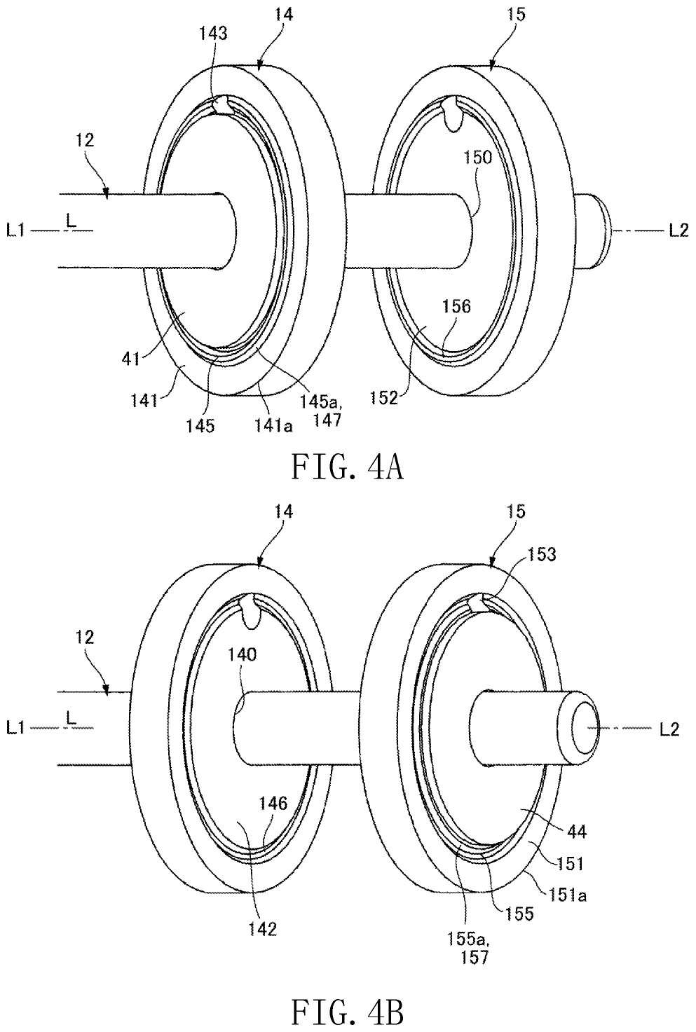

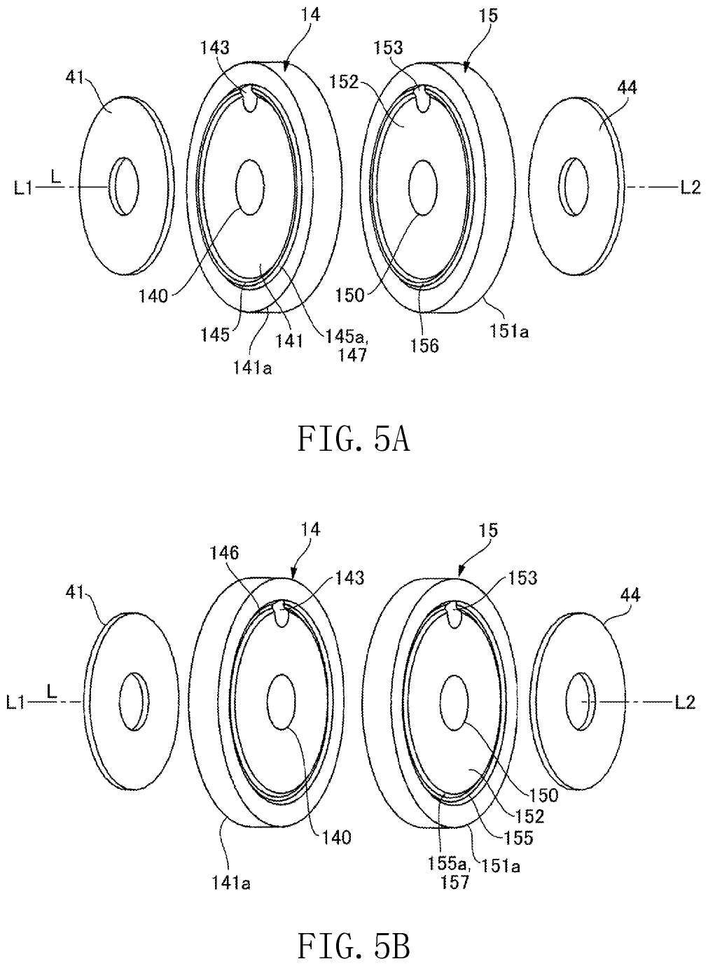

FIG. 2 is a cross-sectional view showing the rotor 10 which is used in the motor 1 shown in FIG. 1. FIG. 3 are explanatory views showing the rotor 10 in FIG. 2 which are viewed in an axial line direction. FIGS. 3(a) and 3(b) are respectively a front view which is viewed from the output side “L1” and a rear view which is viewed from the opposite-to-output side “L2”. FIG. 4 are perspective views showing a state in which the rotor magnet 11 is not shown in the rotor 10 in FIG. 2. FIGS. 4(a) and 4(b) are respectively a perspective view which is viewed from the output side “L1” and a perspective view which is viewed from the opposite-to-output side “L2”. FIG. 5 are exploded perspective views showing the rotor 10 which is disassembled into respective members from the state shown in FIG. 4. FIGS. 5(a) and 5(b) are respectively an exploded perspective view which is viewed from the output side “L1” and an exploded perspective view which is viewed from the opposite-to-output side “L2”. In FIG. 4, adhesives 18 and 19 are not shown.

As shown in FIG. 2, the rotor 10 includes the rotation shaft 12, the rotor magnet 11 in a cylindrical tube shape which is disposed around the rotation shaft 12 so as to be coaxial with the rotation shaft 12, and two plate-shaped bushings (first bushing 14 and second bushing 15) for connecting the rotation shaft 12 with the rotor magnet 11. Each of the first bushing 14 and the second bushing 15 is made of a metal plate. In this embodiment, each of the first bushing 14 and the second bushing 15 is made of an iron-based metal plate whose thickness is about 1 mm through 2 mm. More specifically, each of the first bushing 14 and the second bushing 15 is made of a nonmagnetic stainless metal plate.

As shown in FIG. 2, FIG. 3, FIG. 4, and FIG. 5, the first bushing 14 is a circular plate provided with a center hole 140 to which the rotation shaft 12 is fixed by press fitting or the like, and the first bushing 14 is fixed to an inner peripheral face 110 of the rotor magnet 11 by an adhesive 18 (see FIG. 2 and FIG. 3). More specifically, the first bushing 14 is disposed at a position retracted to the opposite-to-output side “L2” from an end part 111 on the output side “L1” of the rotor magnet 11. The adhesive 18 is applied so as to contact with both of an outer peripheral portion of the first end face 141 on the output side “L1” (outer side) of the first bushing 14 and the inner peripheral face 110 of the rotor magnet 11, and at least an outer circumferential edge 141a of the first end face 141 of the first bushing 14 and the inner peripheral face 110 of the rotor magnet 11 are adhesively fixed to each other. In this embodiment, the adhesive 18 is an ultraviolet curing type adhesive.

An outside diameter of the first bushing 14 is smaller than an inside diameter of the rotor magnet 11. Therefore, a gap space 144 is provided between the outer circumferential edge 141a of the first bushing 14 and the inner peripheral face 110 of the rotor magnet 11. Accordingly, a part of the adhesive 18 enters into an inside of the gap space 144 to adhesively bond the first bushing 14 to the rotor magnet 11.

The first end face 141 of the first bushing 14 is formed with a wall forming part 145 which is one of a groove-shaped recessed part and a rib-shaped protruded part so as to extend in a circumferential direction at a position separated from the outer circumferential edge 141a to an inner side in a radial direction. In this embodiment, the wall forming part 145 is formed by press working to the first bushing 14. Therefore, the second end face 142 of the first bushing 14 which faces an inner side in the axial line “L” direction is formed with the other of the recessed part and the protruded part at a position overlapped with the wall forming part 145.

In this embodiment, the wall forming part 145 is a rib-shaped protruded part which is formed in the first end face 141 and thus, a recessed part 146 is formed in the second end face 142 at a position overlapped with the wall forming part 145. In each of the wall forming part 145 (protruded part) and the recessed part 146, a circumferential face located on an inner side in the radial direction and a circumferential face located on an outer side in the radial direction are formed to be an inclined face. In the first bushing 14, a circumferential face 145a which faces an outer side in the radial direction on the outer side in the radial direction in the circumferential faces of the wall forming part 145 (protruded part) structures an outflow prevention wall 147 for the adhesive 18.

The first bushing 14 is formed with a through hole 143. In this embodiment, the through hole 143 is formed at a position overlapped with the outflow prevention wall 147 and the recessed part 146. Therefore, the through hole 143 is connected with the outflow prevention wall 147 and the recessed part 146, and a part of the through hole 143 is projected to an inner side in the radial direction from the wall forming part 145. In this embodiment, a portion of an edge of the through hole 143 which is the most separated to an outer side in the radial direction from the axial line “L” is overlapped with an outer edge of the wall forming part 145.

When the washer 41 is overlapped with the first end face 141 of the first bushing 14 which is structured as described above, the washer 41 is overlapped with a circular region on an inner side in the radial direction with respect to the wall forming part 145. In this state, the washer 4 is overlapped with a portion of the through hole 143 which is located on an inner side with respect to the outflow prevention wall 147.

The second bushing 15 is structured of the same component as the first bushing 14 and is disposed on the opposite-to-output side “L2” with respect to the first bushing 14. Therefore, the second bushing 15 is fixed to the inner peripheral face 110 of the rotor magnet 11 by an adhesive 19 at a position retracted to the output side “L1” from an end part 112 on the opposite-to-output side “L2” of the rotor magnet 11. The adhesive 19 is applied so as to contact with both of an outer peripheral portion of a first end face 151 on the opposite-to-output side “L2” (outer side) of the second bushing 15 and the inner peripheral face 110 of the rotor magnet 11, and at least an outer circumferential edge 151a of the first end face 151 of the second bushing 15 and the inner peripheral face 110 of the rotor magnet 11 are adhesively fixed to each other. In this embodiment, the adhesive 19 is an ultraviolet curing type adhesive.

An outside diameter of the second bushing 15 is smaller than the inside diameter of the rotor magnet 11. Therefore, a gap space 154 is provided between the outer circumferential edge 151a of the second bushing 15 and the inner peripheral face 110 of the rotor magnet 11. Accordingly, a part of the adhesive 19 enters into an inside of the gap space 154 to adhesively bond the second bushing 15 to the rotor magnet 11.

The first end face 151 of the second bushing 15 is formed with a wall forming part 155 which is one of a groove-shaped recessed part and a rib-shaped protruded part so as to extend in a circumferential direction at a position separated from the outer circumferential edge 151a to an inner side in the radial direction. In this embodiment, the wall forming part 155 is formed by press working to the second bushing 15. Therefore, the second end face 152 of the second bushing 15 which faces an inner side in the axial line “L” direction is formed with the other of the recessed part and the protruded part at a position overlapped with the wall forming part 155.

In this embodiment, the wall forming part 155 is a recessed part which is formed in the first end face 151 and thus, a protruded part 156 is formed in the second end face 152 at a position overlapped with the wall forming part 155. In each of the wall forming part 155 (recessed part) and the protruded part 156, a circumferential face located on an inner side in the radial direction and a circumferential face located on an outer side in the radial direction are formed to be an inclined face. In the second bushing 15, a circumferential face 155a which faces an outer side in the radial direction on an inner side in the radial direction in the circumferential faces of the wall forming part 155 (recessed part) structures an outflow prevention wall 157 for the adhesive 19.

In this embodiment, the second bushing 15 is formed with a through hole 153. In this embodiment, the through hole 153 is formed at a position overlapped with the outflow prevention wall 157 and the protruded part 156. Therefore, the through hole 153 is connected with the outflow prevention wall 157 and the protruded part 156, and a part of the through hole 153 is projected to an inner side in the radial direction from the wall forming part 155. In this embodiment, a portion of an edge of the through hole 153 which is the most separated to an outer side in the radial direction from the axial line “L” is overlapped with an outer edge of the wall forming part 155.

When the washer 44 is overlapped with the first end face 151 of the second bushing 15 which is structured as described above, the washer 44 is overlapped with a circular region on an inner side in the radial direction with respect to the wall forming part 155. In this state, the washer 44 is overlapped with a portion of the through hole 153 which is located on an inner side with respect to the wall forming part 155.

(Principal Effects in this Embodiment)

As described above, according to this embodiment, a portion of the rotor 10 between the rotation shaft 12 and the rotor magnet 11 can be made hollow and thus, a weight of the rotor 10 can be reduced and, in addition, a volume of the rotor magnet 11 can be reduced.

Further, the first end face 141 of the first bushing 14 is formed with the outflow prevention wall 147 by using the circumferential face 145a of the wall forming part 145 which is formed so as to face an outer side in the radial direction at a position separated from the outer circumferential edge 141a to an inner side in the radial direction. Therefore, when an adhesive 18 is applied between the outflow prevention wall 147 and the inner peripheral face 110 of the rotor magnet 11, even in a case that the adhesive 18 is going to flow to an inner side in the radial direction, the adhesive 18 is blocked by the outflow prevention wall 147 and thus, the adhesive 18 is difficult to flow to the inner side in the radial direction. Accordingly, a sufficient amount of the adhesive can be provided between the outflow prevention wall 147 and the inner peripheral face 110 of the rotor magnet 11 and thus, the first bushing 14 and the rotor magnet 11 can be adhesively bonded to each other firmly. Further, the entire area on the inner side in the radial direction with respect to the outflow prevention wall 147 can be utilized as a region for disposing the washer 41 and thus, the washer 41 having a large diameter can be used. Further, in order to provide a sufficient amount of the adhesive 18, for example, a distance from the inner peripheral face of the rotor magnet 11 to the outflow prevention wall 147 may be set longer. Therefore, even in a case that an appropriate amount of the adhesive 18 is to be provided, working to the first bushing 14 is easily performed.

Further, the first bushing 14 is a metal plate, and while the first end face 141 is formed with the wall forming part 145 by using a rib-shaped protruded part, the second end face 142 is formed with the recessed part 146 at a position overlapped with the wall forming part 145. In other words, the wall forming part 145 can be formed by press working to the first bushing 14 (metal plate). Therefore, the first bushing 14 can be manufactured efficiently. Also in this case, it is sufficient that press working to the first bushing 14 (metal plate) is performed at a position separated from the outer circumferential edge 141a to an inner side in the radial direction and thus, in comparison with a case that press working to the first bushing 14 (metal plate) is performed on the outer circumferential edge 141a, the wall forming part 145 and the outer circumferential edge 141a of the first the first bushing 14 are easily finished in appropriate shapes.

Further, also in the first end face 151 of the second bushing 15, similarly to the first bushing 14, the outflow prevention wall 157 is formed by the circumferential face 155a facing an outer side in the radial direction of the wall forming part 155 which is formed at a position separated from the outer circumferential edge 151a to an inner side in the radial direction. Therefore, when an adhesive 19 is applied between the outflow prevention wall 157 and the inner peripheral face 110 of the rotor magnet 11, even in a case that the adhesive 19 is going to flow to an inner side in the radial direction, the adhesive 19 is blocked by the outflow prevention wall 147 and thus, effects similar to the second bushing 15 can be attained, for example, the adhesive 19 is difficult to flow to the inner side in the radial direction. In this embodiment, in the second bushing 15, the wall forming part 155 is structured of a recessed part, and the circumferential face 155a on an inner side in the radial direction of the recessed part is the outflow prevention wall 157. Therefore, when the wall forming part 155 is structured of a recessed part, an adhesive 19 can be allowed to enter to an inner side of the recessed part and thus, in comparison with a case that the wall forming part 155 is structured of a protruded part, an outflow of the adhesive 19 to the inner side in the radial direction can be restrained even when an amount of the adhesive 19 is large.

Further, the first bushing 14 and the second bushing 15 are structured of metal plates having the same structure and thus, even in a case that two bushings (first bushing 14 and second bushing 15) are provided, a common metal plate can be used. Therefore, a component cost can be reduced.

Further, the first bushing 14 and the second bushing 15 are formed with the through holes 143 and 153. Therefore, in a state that the rotor magnet 11 is fixed to the rotation shaft 12 by the first bushing 14 and the second bushing 15, a space surrounded by the rotor magnet 11, the first bushing 14 and the second bushing 15 is communicated with an outer side through the through holes 143 and 153 of the first bushing 14 and the second bushing 15. Therefore, even when air in the space surrounded by the rotor magnet 11, the first bushing 14 and the second bushing 15 expands or contracts with change of environment temperature or the like, the first bushing 14 and the second bushing 15 are difficult to move in the axial line “L” direction. Accordingly, detachment of the adhesives 18 and 19 is difficult to occur. Further, the through holes 143 and 153 are connected with the wall forming parts 145 and 155 and thus, the adhesives 18 and 19 can be stored by using the through holes 143 and 153. Therefore, the adhesives 18 and 19 can be restrained from flowing to an inner side in the radial direction.

### Other Embodiments

In the embodiment described above, water-repellent processing by using a fluorine-based water repellent may be performed on the outflow prevention walls 147 and 157 to impart water repellency to the outflow prevention walls 147 and 157. According to this structure, even when the adhesives 18 and 19 reach the outflow prevention walls 147 and 157, the adhesives 18 and 19 can be restrained from flowing to the outflow prevention walls 147 and 157.

In the embodiment described above, the first bushing 14 is provided with the wall forming part 145 structured of a protruded part formed in the first end face 141, and the second bushing 15 is provided with the wall forming part 155 structured of a recessed part formed in the first end face 151. However, it may be structured that the first bushing 14 is provided with the wall forming part 145 structured of a recessed part formed in the first end face 141 and the second bushing 15 is provided with the wall forming part 155 structured of a protruded part formed in the first end face 151. Further, it may be structured that the first bushing 14 and the second bushing 15 are respectively provided with the wall forming parts 145 and 155 structured of a protruded part, or it may be structured that the first bushing 14 and the second bushing 15 are respectively provided with the wall forming parts 145 and 155 structured of a recessed part.

In the embodiment described above, in the first bushing 14, the through hole 143 is connected with the wall forming part 145. However, it may be structured that the through hole 143 is formed on an inner side in the radial direction with respect to the wall forming part 145. Further, in the second bushing 15, the through hole 153 is connected with the wall forming part 155. However, it may be structured that the through hole 153 is formed on an inner side in the radial direction with respect to the wall forming part 155.

In the embodiment described above, the present invention is applied to both of the first bushing 14 and the second bushing 15, but the present invention may be applied to only one of the bushings.

In the embodiment described above, the rotor magnet 11 is connected with the rotation shaft 12 by using two bushings (first bushing 14 and second bushing 15). However, the present invention may be applied to a case that a bottom plate part of one cup-shaped bushing is fixed to the rotation shaft 12 and that the rotor magnet 11 is fixed to an outer peripheral side of a tube part of the cup-shaped bushing with an adhesive.

In the embodiment described above, an ultraviolet curing type adhesive is used as the adhesives 18 and 19, but a thermosetting type adhesive may be used. Further, a thermosetting type adhesive having ultraviolet curability may be used as the adhesives 18 and 19 and, in this case, after temporary curing is performed by ultraviolet irradiation, complete curing by heating can be performed and thus, when heating for complete curing is to be performed, an adhesive can be restrained from flowing to an inner side in the radial direction.

### REFERENCE SIGNS LIST

1 . . . motor, 1a . . . stepping motor, 10 . . . rotor, 11 . . . rotor magnet, 12 . . . rotation shaft, 14 . . . first bushing, 15 . . . second bushing, 19 . . . adhesive, 20 . . . stator, 141, 151 . . . first end face, 141a, 151a . . . outer circumferential edge, 142, 152 . . . second end face, 140, 150 . . . center hole, 143, 153 . . . through hole, 144, 154 . . . gap space, 145, 155 . . . wall forming part, 145a, 155a . . . circumferential face, 146 . . . recessed part, 156 . . . protruded part, 147, 157 . . . outflow prevention wall, “L” . . . axial line, “L1” . . . output side, “L2” . . . opposite-to-output side

1. A rotor comprising:
a rotation shaft;
a rotor magnet in a cylindrical tube shape which is coaxially disposed with the rotation shaft around the rotation shaft; and
a bushing in a plate shape which comprises:
a center hole to which the rotation shaft is fixed; and
a first end face which faces an outer side in an axial line direction of the rotation shaft, an outer circumferential edge of the first end face being fixed to an inner peripheral face of the rotor magnet with an adhesive;
wherein the first end face is formed with a wall forming part structured of one of a recessed part in a groove shape and a protruded part in a rib shape so as to be extended in a circumferential direction at a position separated from the outer circumferential edge to an inner side in a radial direction; and
wherein the adhesive is provided between an outflow prevention wall which is structured of a circumferential face which faces an outer side in the radial direction of the wall forming part and the inner peripheral face of the rotor magnet and thereby the bushing and the rotor magnet are adhesively fixed to each other.

2. The rotor according to claim 1, wherein
the bushing is a metal plate, and
a second end face of the bushing which faces an inner side in the axial line direction of the rotation shaft is formed with an other of the recessed part and the protruded part at a position overlapped with the wall forming part.

3. The rotor according to claim 1, wherein
each of the protruded part and the recessed part is formed so that each of a circumferential face on an inner side in the radial direction and a circumferential face on an outer side in the radial direction is formed in an inclined face.

4. The rotor according to claim 1, wherein
the bushing is formed with a through hole which penetrates through in the axial line direction.

5. The rotor according to claim 4, wherein
the through hole is connected with the wall forming part.

6. The rotor according to claim 1, wherein
the outflow prevention wall is provided with water repellency.

7. The rotor according to claim 1, wherein
the bushing is provided at two positions separated in the axial line direction.

8. A motor comprising:
the rotor defined in claim 1; and
a stator which faces the rotor magnet on an outer side in the radial direction.

9. The motor according to claim 8, wherein
a washer is provided so as to overlap with the first end face on an inner side in the radial direction with respect to the wall forming part.
